(19) United States
(12) Patent Application Publication
(10) Pub. No.: US 2009/0285387 A1
(43) Pub. Date: Nov. 19, 2009

(54) Symmetric encryption/decryption method of variable length and application thereof

(76) Inventor: Chiou-Haun Lee, Taichung City (TW)

Correspondence Address: CHARLES E. BAXLEY, ESQUIRE, 90 JOHN STREET, SUITE 309, NEW YORK, NY, 10038, US

(21) Appl. No.: 12/152,695

(22) Filed: May 15, 2008

(51) Int. Cl. H04L 9/30

(52) U.S. Cl. 380/30

(57) ABSTRACT

A symmetric encryption/decryption method of variable length and an application of using the method are disclosed. The method is established in a computational structure of diffusion algebra and includes a plaintext (M) and a private key (P). The length of a private key represents a cycle (T), and the cycle is a product of an encryption cycle (Te) and a decryption cycle (Td). The plaintext is encrypted by M^{T}^{ₑ} mod P=C to produce a ciphertext (C), and the ciphertext is decrypted by C^{T}^{_{d}} mod P=M back to the plaintext. In an application, the plaintext represents a check code, and the ciphertext represents a public key, and the private key set composed of at least one private key, several decryption operations of the private key can give a correct check to achieve the effect of one public key and many private keys.

### BACKGROUND OF THE INVENTION

1. Field of the Invention

The present invention relates to a symmetric encryption/decryption method, and more particularly to a method of encrypting/decrypting by using the operation of diffused algebra on a plaintext (M) and a private key (P), and the length of the private key (P) represents a cycle (T), and the cycle (T) is the product of an encryption cycle (Te) and a decryption cycle (Td), and the plaintext is encrypted by M^{T}^{ₑ} mod P=C to produce a ciphertext (C), and the ciphertext is decrypted by C^{T}^{_{d}} mod P=M to recover the plaintext.

2. Description of the Related Art

In conventional data encryption/decryption method, a plaintext and a password go through a series of transposes, XOR, and transformation operations to sufficiently mix the plaintext and the password into a ciphertext, and the ciphertext and the password go through the same algorithm to convert the ciphertext back into the plaintext.

The conventional method must generate substantially no correlation between the plaintext and the ciphertext, and basically the plaintext and the password go through one-dimensional matrix logical operations and two-dimensional matrix transposes, and the key pint for the security resides on the repeated logical operations and matrix transposes in the algorithm.

### SUMMARY OF THE INVENTION

The present invention intends to solve the following technical problems:

In a prior art, a block of data is inputted into a corresponding block with a same size of encoded outputs, and a substantially no correlation is adopted to improve the security of the encryption. The present adopts a plaintext of a variable length, and a ciphertext of a variable length, and the length of the plaintext is not equal to the length of the ciphertext. It is rather impossible to find the corresponding relation between the plaintext and the ciphertext, and such arrangement can further improve the security.

The measures taken by the present invention to solve the aforementioned technical problems:

A plaintext (M) and a private key (P) are selected by using a diffusion algebra operation structure, and the length of the private key represents a cycle (T), and the cycle is a product of an encryption cycle (Te) and a decryption cycle (Td), and M^{T}^{ₑ} mod P=C is used for an encryption to produce a ciphertext (C), and C^{T}^{_{d}} mod P=M is used for a decryption to covert the ciphertext into the plaintext.

Comparison between the Invention and the Prior Art:

The differences between the present invention and the prior art are listed as follows:

1. Length of Plaintext: The prior art adopts a plaintext with a fixed length, but the present invention adopts a plaintext having a length unequal to the length of the ciphertext, so that it is difficult to find out the correlation between the ciphertext and the plaintext.

2. Length of Ciphertext: The prior art requires a module to determine the length of a ciphertext, but the present invention determines the length of the ciphertext by the length of a password, so as to provide a better flexibility.

### BRIEF DESCRIPTION OF THE DRAWINGS

FIG. 1 is a flow chart of producing a private key in accordance with the present invention; and

FIG. 2 is a flow chart of an encrypting and a decryption in accordance with the present invention.

### DETAILED DESCRIPTION OF THE PREFERRED EMBODIMENTS

The symmetric encryption/decryption method of the present invention applies a bit operation of diffusion algebra directly, and the method comprises:

Symbols and Definitions of Diffusion Algebra:

S is a number series, which is a binary one-dimensional matrix composed of n positions, where n>0. The positions are listed below:

| | | | | | |
|---|---|---|---|---|---|
| n − 1 | n − 2 | n − 3 | . . . | 1 | 0 |

eᵢ is an element, and the position i of S is 1, and the remaining positions are 0.

For example, (a) e₀:[1]; (b) eₙ₋₁:[100 . . . 00]

0 is a zero element.

For example, (a) S⊕0=S; (b) S [symbol] 0=0

⊕: Addition.

For example, (a) eᵢ⊕eᵢ=0

[symbol] : Multiplication

For example, (a)

$${e}_{i} ⊗ {e}_{j} = {e}_{i + j} = \{ \begin{matrix} {e}_{i + j} & if i + j < n \\ {e}_{i + j - n} & if i + j \geq n\end{matrix} \}$$

b) (eᵢ⊕eⱼ) [symbol] eₖ=eᵢ₊ₖ⊕eⱼ₊ₖ

mod: a module number, which equals to a remainder of dividing two numbers.

For example, (a)

$${e}_{i} mod {e}_{j} = \{ \begin{matrix} 0 , if i \geq j \\ {e}_{i} , if i < j\end{matrix} \}$$

Sⁱ:S to the power of i.

For example: (a) S⁰=1; (b) S¹=S; (c) S²=S [symbol] S;

(d) Sⁱ [symbol] S^{j}=S^{i+j}; (e) (Sⁱ)^{j}=S^{i×j}

P is a prime number, which is a number divisible by 1 and itself only.

For example, (a) [11]; (b) [111]; (c) [11001]

T is a cycle.

For example, (a) A^{T} mod P=A, T=2ⁿ⁻¹

$$( b ) S = {\prod }_{i} {S}_{i} , {S}_{i} ∈ P \{ \begin{matrix} T = {2}^{n - 1} \\ T = {2}^{max ( {n}_{i} ) - 1}\end{matrix}$$

Private Key

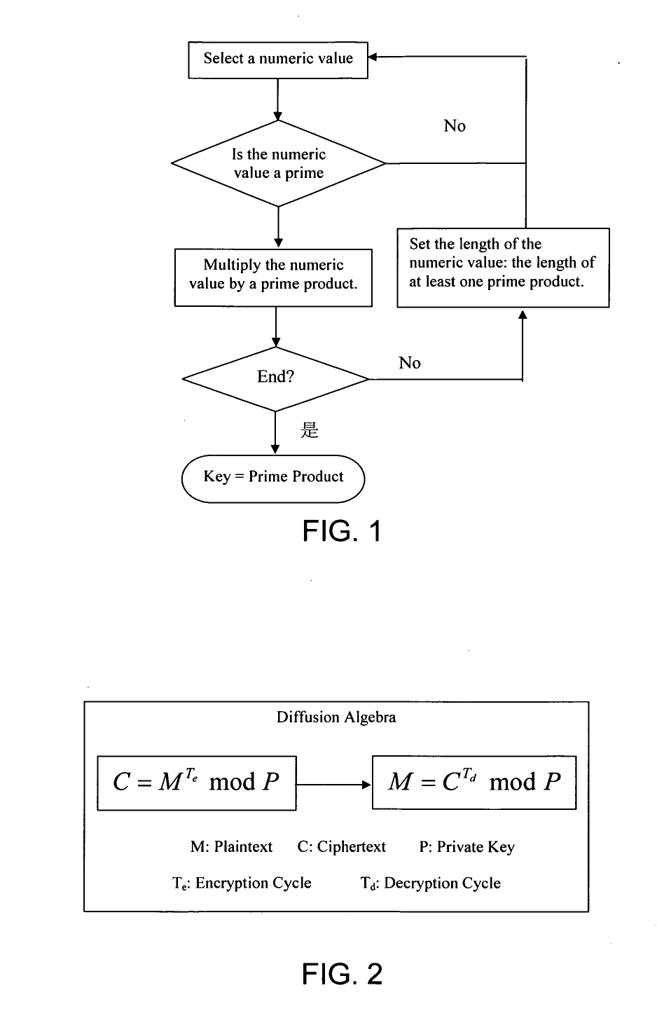

A private key S is produced as shown in FIG. 1 and according to the method below.

1. SεP, Select a prime number.

2.

$$S = {\prod }_{i} {S}_{i} , {S}_{i} ∈ P ,$$

where S is a product of at least one different prime number Si; and the length of Si is equal to the length of the product of at least one different prime number of S.

Encryption and Decryption:

A plaintext (M) and a private key (P) are selected by an operation structure of diffusion algebra, and the length of the private key is a cycle (T), and the cycle is a product of an encryption cycle (Te) and a decryption cycle (Td), and the encryption/decryption as shown in FIG. 2 comprises the following steps:

1. M^{T}^{ₑ} mod P=C; (Plaintext Encryption)

2. C^{T}^{_{d}} mod P=M; (Ciphertext Decryption)

Example of Encryption and Decryption

To make it easier for our examiner to understand the technical contents of the present invention, the operations of diffusion multiplication, module number, encryption and decryption, and 65 bit combination are described as follows:

Let an 8-bit plaintext be s=[11011010] and a 9-bit private key be p=[100101011]

Diffusion Multiplication:

s [symbol] s=s [symbol] (e₇⊕e₆⊕e₄⊕e₃⊕e₁)=s [symbol] e₇⊕s [symbol] e₆⊕s [symbol] e₄⊕s [symbol] e₃⊕s [symbol] e₁=[101000101000100]

Module Number:

s [symbol] s mod p=[101000101000100] mod [100101011]=[1101100]

∵[101000101000100]=[100101011] [symbol] [1011000]⊕[1101100]

Encryption and Decryption:

T=Tₑ×T_{d}=2⁹⁻¹ if Tₑ=T_{d}=\sqrt{T}

C=M^{\sqrt{T}} mod p=s²^{⁴} mod p=[11111]

M=C^{\sqrt{T}} mod p=[11111] mod p=s

Practical Application Plaintext Encryption/Decryption

For 65 bits:

Private Key:

P: Prime Number (65 bits), T=2⁶⁴

1101101001101100110100000010011000100111

0000011101001100101100001

Encryption and Decryption:

M: Plaintext (61 bits) with a length smaller than 65 bits.

1110011111110110111011100010100011110110

001000010011000111001

C: Ciphertext (56 bits), Encryption: C=M^{\sqrt{T}} mod p

1111011001010101000010101110001010000010

1111010110000111

M: Plaintext (61 bits), Decryption: M=C^{\sqrt{T}} mod p

Combination of 65 bits:

Select and multiply two 65-bit prime number, and the product is a private key, and the private key cycle can select T=2⁶⁴ or T=2¹²⁸.

Numeric Value:

p: Prime Number (65 bits), T=2⁶⁴

1101101001101100110100000010011000100111

0000011101001100101100001

q: Prime Number (65 bits), T=2⁶⁴

1010100100000100011001011110010111000001

0100001000111100111000001

Private Key: pq=p [symbol] q (129 bits), T=2⁶⁴

1110000011100011011111111010011111110010

0100000100111111011011001110101100101110

1011010000111101110111011010100000110100

010100001

Encryption and Decryption:

M: Plaintext (127 bits) with a length smaller than 129 bits.

1011101010001101100001011110111101110100

1001000011100110101101101010001100000101

0010110101000101111110000011011101011001

1011101

C: Ciphertext (125 bits), Encryption: C=M^{\sqrt{T}} mod pq

1100100011110000001000011110110100101011

0001011010011100110111111011101110000101

1100011101011110100111001111010011101010

00000

M: Plaintext (127 bits), Encryption: M=C^{\sqrt{T}} mod pq

Advanced Combination of 65 bits:

The combination of 65 bits is multiplied by a prime number to give a private key, and the length of the prime number is set to 65 bits or 129 bits. For the 65 bits, the private key cycle can be selected as T=2⁶⁴ or T=2¹⁹². For the 129 bits, the private key cycle can be selected as T=2¹²⁸ or T=2²⁵⁶.

Numeric Value:

P: Prime Number (65 bits), T=2⁶⁴

1101101001101100110100000010011000100111

0000011101001100101100001

Q: Prime Number (65 bits), T=2⁶⁴

1010100100000100011001011110010111000001

0100001000111100111000001

r: Prime Number (129 bits), T=2¹²⁸

1100011011011011111101001100100100011010

0011110011011010001011110001011010011011

0011010000001001100010011100000111010011

001011011

Private Key: pqr=p [symbol] q [symbol] r (257 bits), T=2¹²⁸

1001010010010110001001111000101011110111

0111100110110011100000100001001001111110

1111010000101010011101011110101010100000

0000010100011000000010111010100111111101

0101100001001100101001110100011000101001

0100100110001100101011001101101000011101

10011100010111011

Encryption and Decryption:

M: Plaintext (256 bits) with a length smaller than 257 bits.

1011101000000110011011111001011011010000

1010001111010011000110001010010110010110

0100000011100000111110100010000001100101

1100100101011000110001100101101000001001

1011101110010000000000101100010101000100

1100101111010100100101101010011111101000

0111100000110101

C: Ciphertext (225 bits), Encryption: C=M^{\sqrt{T}} mod pqr

1111111100011010000011101110010001001101

1110001101110110001100001101011001111110

1111101110100000110110001010010001111111

0101111110100000010010001111000101111001

1001111000100101010010110101110000010101

1111000110101100011010100101001101001110

001101000111011

M: Plaintext (256 bits), Encryption: M=C^{\sqrt{T}} mod pqr

Practical Application Opening Different Keys

In the encryption and decryption, the plaintext represents a check code, and the ciphertext represents a public key, and the decryption operation represents a check operation.

Combination of 65 bits:

The length of the check code is less than 65 bits, so that the three different keys p, q, pq can open the public key; and the length of the check code is more than 64 bits and less than 129 bits, so that the key pq can open the public key.

Private Key:

P: Prime Number (65 bits), T=

1101101001101100110100000010011000100111

0000011101001100101100001

q: prime number (65 bits), T=2⁶⁴

1010100100000100011001011110010111000001

0100001000111100111000001

Pq: Combination P [symbol] q (129 bits), T=2⁶⁴

1110000011100011011111111010011111110010

0100000100111111011011001110101100101110

1011010000111101110111011010100000110100

010100001

Producing Three Keys:

M: Check Code (61 bits) with a length smaller than 65 bits.

1110011111110110111011100010100011110110

001000010011000111001

C: Public Key (126 bits), Encryption: C=M^{\sqrt{T}} mod pq

1100000001110011101101110011000000011111

0101010100101110011111010101111000100101

1010110011110110101010111100000110101011

101011

| | |
|---|---|
| Key1: p | Check: C^{\sqrt{T}} mod p = M |
| Key2: q | Check: C^{\sqrt{T}} mod q = M |
| Key3: pq | Check: C^{\sqrt{T}} mod pq = M |

Advanced Combination of 65 Bits:

The length of the check code is less than 65 bits, and the seven different keys p, q, r, pq, pr, qr, pqr can open the public key. If the length of the check code is more than 128 bits, then the p, q, r will be eliminated. If the length of the check code is more than 192 bits and less than 257 bits, then the key pqr will be able to open the public key.

Private Key:

P: Prime Number (65 bits), T=2⁶⁴

1101101001101100110100000010011000100111

0000011101001100101100001

Q: Prime Number (65 bits), T=2⁶⁴

1010100100000100011001011110010111000001

0100001000111100111000001

R: Prime Number (129 bits), T=2¹²⁸

1100011011011011111101001100100100011010

0011110011011010001011110001011010011011

0011010000001001100010011100000111010011

001011011

Pqr: Combine p [symbol] q [symbol] r (257 bits), T=2¹²⁸

1001010010010110001001111000101011110111

0111100110110011100000100001001001111110

1111010000101010011101011110101010100000

0000010100011000000010111010100111111101

0101100001001100101001110100011000101001

0100100110001100101011001101101000011101

10011100010111011

Producing a Plurality of Keys:

M: Check code (61 bits) with a length smaller than 65 bits.

1110011111110110111011100010100011110110

001000010011000111001

C: Public Key (256 bits), Encryption: C=M^{\sqrt{T}} mod pqr

1000101110111111000010010000111011111111

0100001100000010001110010101100011100000

1010000011101001011010100110101110000001

0011001010101101000111001000110010011010

0010011101010110011101011000010001010111

0001101011100001111000010101101001010001

1100011000100011

| | |
|---|---|
| Keys1: p, q, r | Check: C^{\sqrt{T}} mod p = M |
| Keys2: pq, qr, pr | Check: C^{\sqrt{T}} mod pq = M |
| Key7: pqr. | Check: C^{\sqrt{T}} mod pqr = M |

In the encryption and decryption application of this embodiment, the length of the ciphertext is unequal to the length of the private key, and it takes more time than the prior art to crack the private key by the ciphertext. Similarly, in an application of unlocking a different key, if the length of the public key is unequal to the length of the private key set, it takes longer time than the prior art to find any private key from the private key set based on the public key.

While preferred embodiments of the invention have been shown and described in detail, it will be readily understood and appreciated that numerous omissions, changes and additions may be made by persons ordinarily skilled in the art without departing from the spirit and scope of the invention.

What is claimed is:

1. A symmetric encryption/decryption method of a variable length, established in a diffusion algebra operation structure, comprising a plaintext (M) and a private key (P), and the length of the private key representing a cycle (T), and the cycle being a product of an encryption cycle (Te) and a decryption cycle (Td). And the plaintext (M) is decrypted by M^{T}^{ₑ} mod P=C to produce a ciphertext (C), and the ciphertext (C) is decrypted by C^{T}^{_{d}} mod P=M to obtain the plaintext (M).

2. The method of claim 1, wherein the plaintext has a length smaller than the length of the private key.

3. The method of claim 1, wherein the private key is a product of at least one prime number; and the prime number is a number indivisible by any number except the number and 1.

4. The method of claim 3, wherein the prime number has a length equal to the length of a product with at least one different prime number of the private key.

5. The method of claim 1, wherein the cycle T=2^{L-1}, and L is the length of the private key.

6. The method of claim 4, wherein the cycle T=2^{L-1}, and L is the length of the largest prime of the private key.

7. The method of claim 1, wherein the Tₑ=T_{d}=\sqrt{T} is set, if the length of the private key is an odd number.

8. A symmetric encryption/decryption application of a variable length, established on a diffusion algebra operation structure, comprising a check code (M) and a private key set (Ps), and the private key set comprising a private key (Pi); the length of the private key set being a cycle (T), and the cycle being a product of an encryption cycle (Te) and a decryption cycle (Td); M^{T}^{ₑ} mod Pₛ=C being used for producing a public key (C), and at least one private key of the private key set being selected, and correct check being obtained by C^{T}^{_{d}} mod Pᵢ=M, to achieve the effect of one public key and many private keys.

9. The method of claim 8, wherein the private key has a length greater than the length of the check code.

10. The method of claim 8, wherein the private key set is a product of at least one prime number, and the prime number is a number indivisible to any number except the number and 1.

11. The method of claim 10, wherein the prime number has a length equal to the length of a product of at least one different prime number of the private key set.

12. The method of claim 10, wherein the prime number is equal to the private key.

13. The method of claim 10, wherein the prime number and at least one prime number of the private key set are multiplied to give a product equal to the private key.

14. The method of claim 8, wherein the cycle has a power of T=2^{L-1}, and L is the length of the private key set.

15. The method of claim 11, wherein the cycle has a power of T=2^{L-1}, and L is the length of the largest prime number of the private key set.

16. The method of claim 8, wherein the Tₑ=T_{d}=\sqrt{T} is set if the length of the private key set is an odd number.
